(19) United States
(12) Patent Application Publication
(10) Pub. No.: US 2011/0026703 A1
(43) Pub. Date: Feb. 3, 2011

(54) UNIVERSAL ADDRESSING OF A COMMUNICATION PARTNER BY MEANS OF TRANSPARENT STATIC PROVISION OF A CALL NUMBER

(76) Inventors: Gerhard Kramarz-Von-Kohout, Bonn (DE); Edwin Fischer, Cologne (DE)

Correspondence Address: KF ROSS PC, 5683 RIVERDALE AVENUE, SUITE 203 BOX 900, BRONX, NY, 10471-0900, US

(21) Appl. No.: 12/935,292

(22) PCT Filed: Feb. 18, 2009
(86) PCT No.: PCT/EP09/01159

§ 371 Date: Oct. 5, 2010

(30) Foreign Application Priority Data
Apr. 15, 2008 (DE) 10 2008 019 033.0

(51) Int. Cl. H04M 3/44

(52) U.S. Cl. 379/216.01

(57) ABSTRACT

The invention relates to a method for establishing a communication connection between a calling user A and a user B to be called in a communication system, in particular a telecommunication fixed network and/or a mobile radio network and/or a computer network or a combination of said networks, wherein a sequence of numbers is generated from a sequence of numbers uniquely identifying the user B for calling, for example, e-mail addresses, aliases, christian names and surnames, by means of a unique representation and a connection establishment is initiated using said sequence of numbers as a call number for the user B.

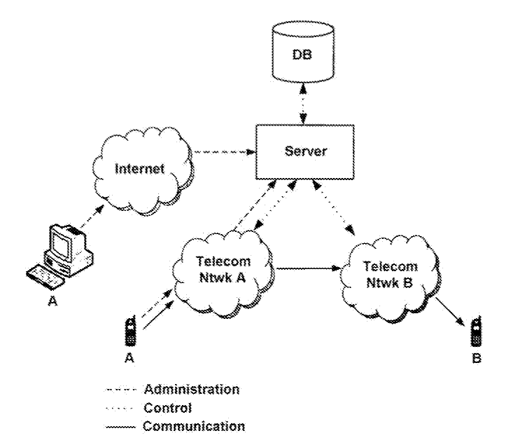

The invention relates to a system that provides a universal addressing method of setting up a communication connection between a calling subscriber A and a called subscriber B of a communication system, in particular a fixed telecommunication network and/or a mobile radio network and/or an Internet protocol-based computer network or a combination of these networks.

It is known to initiate a communication link between a calling subscriber A and a called subscriber B by entering a phone number of the B subscriber. So-called vanity phone numbers are also known that are word-dial phone numbers. These vanity phone numbers are phone numbers that are shown as a word with the aid of the letter selection. Letters are thereby only assigned to the numbers of the telephone keypad, so that a memorable term, instead of a phone number, can be shown. The assignment is carried out based on a recommendation of the International telecommunication Union (ITU). The letters A, B and C thus correspond to number 2.

Since the number of digits of a phone number is limited (no more than 15), only very few characters (usually 8) are available for the actual vanity character string because of the digits for international code and national code/service identifier, such as 0700. These characters from the vanity character string may be only numbers or letters. Special characters are not admissible. No distinction is made between upper case letters and lower case letters. In addition appended characters (for example 0800-TELEKOMBONN) correspond to post-dialed digits (BONN corresponds to 2666), which as a rule do not have any influence on the telecommunication connection.

The phone number corresponding to the vanity character string is firmly assigned to the applicant upon registration by the regulator, i.e. the competent authority for assigning these phone numbers, so that uniqueness is ensured in order that further letter combinations with the same assigned phone number are no longer permissible.

As a rule, the vanity phone numbers are used only virtually. In the associated server the owner of the vanity phone number can assign thereto several phone numbers of mobile or fixed telephone connections, which ensure via the forwarding rules (for example sequence, time-dependent) the actual accessibility after establishment by the user.

The vanity character strings establish a static assignment between character string and phone number.

The length of a vanity character string is limited, the permissible character set is also limited. The keypads of today's terminals generally support only this character set.

Nowadays the addressing is furthermore always carried out in a service-related manner. For example, it is not possible to call an e-mail address (voice call).

An e-mail address such as info@telekom.de cannot be used directly to establish a telecommunication voice connection, not even by vanity phone numbers: “@” and “.” are not on the telephone keypad, so even this short e-mail address is already composed of 15 characters, much more than permissible for a vanity character connection.

An arbitrarily selected name (alias or nickname such as, for example “Fritz_the_tiger”) cannot be used either to establish a telecommunication voice connection.

The object of the invention is to further develop a method of the type described above such that the disadvantages of the prior art are overcome and the establishment of a communication connection is possible without the cited limitations, in particular using any character strings such as, for example, an e-mail address.

This object is attained according to the invention by the method according to claim 1. Further advantageous embodiments of the inventions are given in the dependent claims.

It is particularly advantageous in the method of establishing a communication connection between a calling subscriber A and a called subscriber B of a communication system, in particular a fixed telecommunication network and/or a mobile radio network and/or an Internet protocol-based computer network or a combination of these networks that a digit string is determined from a character string uniquely identifying the called subscriber B by means of a unique image from the character string and a connection to a phone number of the B subscriber, which is derived from the digit string, is established.

Through the clear determination of the phone number from a character string that uniquely identifies the B subscriber but can be established as desired per se, it is thus possible to establish a connection to this phone number.

It is particularly advantageous that the method according to the invention can be easily applied in existing telecommunication networks because in particular the system of the number of digits of a phone number limited to a maximum of 15 remains unaffected.

With the method according to the invention it is possible to use addresses that do not follow any existing address format, but are composed of different characters such as upper case letters, lower case letters, digits, special characters in any desired number. The actual name of the person made up of first name and/or last name, the e-mail address of this person, an alias or nickname, for example, also a nickname, an order name or a stage name, as well as a character string without any recognizable meaning are thus permissible addresses. A phone number can be assigned to an address of this type according to the invention in a transparent and static manner. The assignment is on the one hand transparent, since the assignment of phone number to character string is understandable to anyone, and on the other hand static, since just one phone number belongs to one character string (depending on the specific implementation of the method according to the invention).

If the e-mail address is selected as the address, there is also the advantage that one can be reached via an e-mail address not only by e-mail but now also by telephone. The user thus now needs only one address for both e-mail and telephone service.

Preferably, the above-mentioned image is a function, in particular a hash function, by means of which a digit string is determined from a character string.

Preferably, the character string uniquely identifying the B subscriber is the first name and/or last name and/or an e-mail address, and/or an alias, in particular a nickname or a stage name or an order name or a combination of the above-described variants.

In a preferred embodiment of the method according to the invention an identifier of the A subscriber is transmitted to the communication system in a network-based or Web-based manner, such as, for example, the phone number of the A subscriber or also a character string uniquely identifying the A subscriber such as, for example, his first name and/or last name and/or his e-mail address and/or his alias and/or IP address or the like, which is suitable for uniquely identifying the A subscriber. After the identification in the communication system the phone number of the A subscriber can be determined with which the establishment of the communication connection desired by the A subscriber is to be carried out.

The transmission of the character string identifying the B subscriber can be carried out by direct conversion into a phone number, for example, via a function of the telecommunication terminal of the caller (A subscriber) or by transmission of the character string via a data channel to the telecommunication system or by transmission of a message to the communication system containing this character string, for example, by e-mail, SMS, MMS, Instant Messaging (IM) or the like.

In a particularly preferred embodiment it is possible to transmit a notification to the B subscriber in the event of a failed or rejected connection setup, in particular a notification of this type can contain an identifier of the A subscriber and/or call date and call time. In particular a notification of this type can be transmitted to the B subscriber by SMS, MMS, Instant Messaging (IM) or the like.

Preferably, time restrictions or stipulations for a connection setup can be established, in particular times can preferably be established in which no connection setup or only a connection setup with certain identifiers occurs, and/or the time/date for a first attempt at a connection setup can be specified.

It is hereby possible, for example, to agree on a connection setup in advance for a specific day and a specific time, for example, for a meeting appointment, and to specify in the communication system, i.e. that a connection setup does not have to take place at the time of transmission of the communication order, but can take place at a later time.

In a preferred embodiment of the method according to the invention it is possible for conference calls also to be established with any number of subscribers.

The core of the realization on the basis of an image by means of a function such as a hash function is the selection of a hash function H that assigns an 8-digit decimal number (optionally with leading zeros such as, for example, 00023456) to an address of an arbitrary character set.

As in the case of the above-mentioned vanity phone numbers, for example, this is to be based on 8 digits, which are available to be selected freely. These, for example eight digits identify the B subscriber and, in order to form a call number, are to be supplemented accordingly, for example, by the preceding digits for the national/international code and/or for a service identifier such as, for example +49777 or 0777.

Depending on the number of digits for the national/international code and for the service identifier, instead of 8 digits the above-mentioned decimal number can also accordingly contain more or fewer digits.

According to the above example, the phone number +4977700023456 can thus be determined from a character string identifying the called subscriber B by means of the hash function H. Then a corresponding connection to this phone number is established.

As a rule, the B subscriber will use this phone number only virtually in a similar manner to the vanity phone numbers. In the associated communication system, the B subscriber can assign several phone numbers of mobile or land-line telephone connections to his phone number according to the invention, which via forwarding rules (for example sequence, time-dependent) ensure the actual accessibility after establishment by him.

A hash function is a function that produces precisely one output from a (generally) smaller target quantity (the hash values, for example, a part of the natural numbers) to an input from a (usually) large source quantity.

Hash functions differ in the definition quantity of their inputs, the target quantity of the possible outputs, and in the influence of patterns and similarities of different inputs on the output.

A good hash function is characterized in that it produces few collisions for the inputs for which it was designed. Most inputs can thereby be differentiated based on their hash value.

The hash function H here has only the property to use as a target quantity the decimal numbers of corresponding length, wherein leading zeros can be admissible and as a definition quantity character strings in desired maximum length (for example 100 characters or also “of any length”) from a desired character set (for example ASCII as 7 bit coding with 128 characters or UTF 8 as 8 bit coding with 256 characters).

Thus H could convert, for example, a hexadecimal number (written in hexadecimal, an 8 bit character lies between 00 and FF, several such characters accordingly lead to a longer hexadecimal number) into the associated decimal number (01FF corresponds, for example, decimally 256+255=511). The last 8 digits of this decimal number produced in this manner then produce the hash value H, which represents the phone number or the individual portion thereof. The establishment of a telecommunication connection is triggered to this phone number. This example is intended merely to better explain the principle of a hash function by way of example. Alternatively, the selection of a different H function would also be possible.

In order now to be able to use this type of arbitrary sequence of characters, such as, for example

An e-mail address such as info@telekom.de,
A character chain indicating the user, such as “Fritz Müller from 53227 Bonn” or

An alias such as “Fritz the tiger”

as a target address for a call setup, the function H is now first applied to the character string so that a decimal number (for example 76984523) results as a hash value. This decimal number can then be expanded into a phone number by adding the digits for the international code and national code/service identifier, for example, as follows +49 777 76984523.

This assignment of a telephone number to a character string is transparent and static. It is transparent because anyone who knows and can use H can produce the assignment. It is static because there is only one associated and thus unique telephone number for a character string (with stipulated H and stipulated international code and national code/service identifier.

It is generally not possible to find a matching character string to a stipulated telephone number depending on the specific hash function H, which when H is used is converted into this telephone number.

This phone number is assigned to the person who has reserved this phone number. A prior reservation/logon to the service is mandatory, as with the vanity service, since a hash function H is not fundamentally collision-free, i.e. different character strings could receive the same hash value. If the hash value has 8 digits, however, up to 100,000,000 B subscribers could still use this service and be uniquely identified, since there are 100,000,000 8-digit decimal numbers and a corresponding number of different phone numbers.

By varying the international code or the national code/service identifier assigned to this service, the possible maximum number of subscribers can be substantially increased even further.

To distinguish such character strings and phone numbers, preferably no phone numbers or numerical character strings should be used in the output addressing as an alias or nickname, although this possibility is basically available.

Below various embodiments are shown of how, on the basis of a given hash function H, a conversion of a character string into a phone number and the setup of a telecommunication connection can be carried out.

Preferably, the determination of the digit string is made from the character string by means of the telecommunication terminal of the calling subscriber A or in that the character string is transmitted to the communication system and then the determination of the digit string is carried out by the communication system from the character string that serves as a basis for the phone number.

Case 1: “Offline” Implementation

To this end, the selected hash function must be implemented on the telecommunication terminal, on the optionally associated chip card (for example SIM) or on an independent (for example, calculator-like or PDA-like) ancillary device that is optionally designed specifically only for this purpose, that is, only for the application of the function H. The telecommunication terminal or the ancillary device in addition must provide an input option for the characters of the desired character set.

After the entry of the character string, the call and application of the hash function H must then be possible. The phone number to be called can be generated manually by the user or automatically by the telecommunication terminal/ancillary device from the hash value in that the necessary digits for international code and national code/service identifier are placed at the start. The setup of the telecommunication connection can be carried out based on this phone number in that the phone number is dialed manually by the user or automatically by the telecommunication terminal.

Case 2: “Online” Implementation

Alternatively, the determination of the digit string as the basis of the phone number is carried out by a service server that sets up the communication connection, in particular by a server in the communication system. In order for the service server to be able to set up such a communication connection, it must have the necessary links to the communication networks and communication protocols involved.

The user interface for the A/B subscribers to this service is telecommunication network-based and/or Web-based.

A network-based user interface uses the link of the server to a telecommunication network or to several communication networks so that the user can transmit the data he desires to the server via a voice connection and/or data connection (for example by means of SMS).

A Web-based user interface uses the link of the server to the Internet so that the user, for example, can transmit the desired data to the server with a PC connected to the Internet and corresponding browser software. In order to avoid abuse, an account with a user name and a password or a PIN, i.e. a personal identification number, is necessary as a rule.

In the online implementation, the hash function is not implemented with the user, i.e. with the calling subscriber A in his telecommunication terminal or ancillary device, but in the service server.

Both implementation variants can also be operated in parallel so that some users can use terminals with implemented hash function and some users can use the service server.

In order to be able to use the service server, the user must register and transmit the character string that he wants to dial to the service server. This can be carried out via different communication paths:

Via the Web portal of the service server:
The user (A subscriber) enters, i.e. it is transmitted via an input interface via the Internet to the server:
   a) His own phone number/character string,
   b) The phone number/character string to identify the desired telecommunication partner (B subscriber).
The service server applies the hash function H to the entered character strings, determines the associated phone numbers and sets up a telecommunication connection between the A subscriber and his telecommunication partner (B subscriber) on the basis of these phone numbers.
Through a personalization of the portal (by means of cookies, registration) the repeated entry of one's own telephone number/character string can be omitted.

By the voice portal of the service server:
The user (A subscriber) enters the telephone number/character string of the desired telecommunication partner via an interface that renders possible an identification and translation of voice entries. Furthermore, the A subscriber enters his own telephone number/character string (if his own telephone number has not already been transmitted by CLI (calling line identification)). The service server applies the hash function H to the given character strings, determines the associated phone number(s) and on the basis of this/these phone number(s) sets up a telecommunication connection between the A subscriber and the B subscriber, i.e. the desired telecommunication partner.

By SMS to the service server:
The A subscriber (user of the service) sends an SMS to the service server, for example via a special quick dial such as 55555, with the exemplary content “call,” followed by a character string.
The service server evaluates the SMS received including the sender phone number (CLI calling line identification), applies the hash function H (implemented in the service server) to the character string and on the basis of these two phone numbers can set up a telecommunication connection between the user (A subscriber) and the desired telecommunication partner (B subscriber).

In a further embodiment, the SMS can contain the parameters of date and time in addition so that the user if desired can also stipulate the date and time for when the telecommunication connection should be set up. If the SMS does not contain these parameters, the telecommunication connection will be set up immediately.

The use of the service is thus possible via voice portal or via SMS even if Internet access is temporarily unavailable.

In addition to these embodiments via three different communication paths, further embodiments are also possible:
Conference with more than two subscribers
Call or conference initiated by a third party

To this end, for a service implementation the entry possibilities in the Web portal or the voice portal must be expanded accordingly.

For a service implementation via SMS, the syntax must be expanded, for example, as follows:
Conference
Call character string1<separator>character string2<separator> . . . <separator>character string_n
Call or conference by third parties
call character string1<separator>character string2<separator> or
call character string1<separator>character string2<separator> . . . <separator>character string_n<separator>
   <separator> means a character string defined for this service with the aid of which it is possible to evaluate the various components of the SMS content (similar to the meaning of the “@” symbol for separating the local and global portion of an e-mail address). The <separator> character string must not occur in the actual character string for addressing a communication subscriber; example: “#” as <separator>, hence “call Fritz_the_tiger#maxmeierbonn#.”

A <separator> at the end of the last character string here indicates to the system that the call is not be set up by the sender of the SMS but from the last phone number derived from character string2 or character string_n.

In order to avoid abuse, the invoicing of such calls is preferably carried out via the sender of the SMS (or via the registered user of the Web portal or via the caller of the voice portal).

Example: “#” as <separator>, thus

“call fritz_the_tiger#meier@telekom.de#022899361234”.

An address such as “maxmeier#bonn” would not be permissible if # is established as a separator.

With the above character string, thus a conference is set up via the service according to the invention with the following conference subscribers:
Caller (A subscriber) (corresponds to the sender of the above character string)
1^{st} called party (1^{st} B subscriber) with the alias “fritz_the_tiger”
2^{nd} called party (2^{nd} B subscriber) with the e-mail meier@telekom.de
3^{rd} called party (3^{rd} B subscriber) with the phone number 02289361234

An embodiment of the invention is shown in the drawing and is explained below.

In the drawing the communication link is shown by solid lines, while the administration is shown by dashed lines and control links are shown by dotted lines.

In the example shown, the telecom network A is a mobile radio network. The telecom network B in which the B subscriber terminal B of the desired contact B is logged on can also be the same or a different mobile radio network. However, the invention is not limited to the example shown of mobile radio subscribers A and B, in fact the telecommunication networks A and B can be mobile radio networks, fixed telephone networks or also the Internet.

To set up a communication link from caller A to called party B, i.e. from the A subscriber to the B subscriber, the character string identifying the B subscriber is transmitted by the A subscriber by means of his terminal A to the telecommunication network telecom network A. The A subscriber terminal A is thereby logged on to the telecommunication network telecom network A.

The transmission of this character string identifying the B subscriber can be carried out via the telecommunication terminal A of the caller (A subscriber) by direct input of the character string or by transmission of a message containing this character string to the communication system, for example by e-mail, SMS, MMS, Instant Messaging or the like, i.e. in the example shown by transmission via the telecom network A to the server integrated into the communication system.

The actual name of the person comprising first name and/or last name or the e-mail address of this person or an alias or a nickname, for example, also a nickname, an order name or a stage name, but also a character string without any recognizable meaning can be used as character string. The character string can be composed of upper case and/or lower case letters as well containing as special characters.

The entire communication system has a server connected to a database DB. The character string identifying the B subscriber is transmitted in the form of an inquiry from the telecommunication network telecom network A to the server, which by means of an assignment function in the form of a hash function H determines the associated hash value, i.e. the telephone number of the B subscriber corresponding to this character string in the telecommunication network telecom network B.

In order to be able to use the entered character string as target address for a call setup, therefore first the hash function H is applied to the character string so that a decimal number such as, for example 76984523 results as a hash value. This decimal number is then developed into a phone number in that the numbers for the international code and the national code or telecommunication network identifier are added, such as, as follows +49 777 76984523.

This assignment of a telephone number to a character string is transparent and static. It is transparent because anyone who knows and can use H can produce the assignment. It is static because for a character string (with stipulated H and stipulated international code and national code/service identifier) there is only one associated and thus unique telephone number.

The assignment is thus carried out in a particularly advantageous and simple manner by the server that, using the algorithm of the hash function, upon receipt of the character string determines the phone number corresponding to this character string of the B subscriber to be called in the telecommunication network B.

It is generally not possible to find a matching character string to a predetermined telephone number depending on the specific hash function H that with the use of H is converted into this telephone number.

This phone number is assigned to the person who has reserved this phone number. A prior reservation/logon to the service is mandatory since a hash function H is not fundamentally collision-free, i.e. different character strings could receive the same hash value. If the hash value has 8 digits, however, up to 100,000,000 B subscribers could still use this service and be identified uniquely, since there are 100,000,000 8-digit decimal numbers and a corresponding number of different phone numbers. To this end, i.e. to acquire and store the registered phone numbers, the server has a corresponding database DB, as shown in the drawing.

The user interface for the A subscriber to this server is telecommunication network-based and/or Web-based, i.e. via the telecommunication network telecom network A as well as furthermore via Internet-based interfaces by means of a computer A, as shown in the drawing.

Using the telephone number of the B subscriber determined by the server as described above, the communication link can then be set up between A (caller) and B (called party) via the telecom network A and telecom network B.

The service server applies the hash function H to the entered character strings, determines the associated phone numbers and on the basis of these telephone numbers sets up a telecommunication link between the A subscriber and his telecommunication partner (B subscriber).

As indicated in the drawing, links from or to a terminal using the Internet can also be set up, in particular the terminal by means of which the alias, i.e. the identifier character string of the B subscriber to be called can be transmitted, as shown in the drawing, can be a computer connected to the Internet.

Via administration of the server inside the communication system there is also the possibility (not shown) of setting up a conference call with more than two subscribers.

1. A method of setting up a communication connection between a calling subscriber A and a called subscriber B of a communication system, in particular a fixed telecommunication network and/or a mobile radio network and/or an Internet protocol-based computer network or a combination of these networks, a digit string being determined from a character string uniquely identifying the called subscriber B by means of a unique image from the character string and a connection is established using a phone number of the B subscriber derived from this digit string, wherein the image is a hash function by means of which a digit string is determined from a character string and that the digit string serves as a basis of the phone number, the digit string being transformed into the call number by addition of an international and/or national code and/or service identifier.

2. The method according to claim 1, wherein the determination of the digit string is made from the character string by means of the telecommunication terminal of the calling subscriber A.

3. The method according to claim 1, wherein the character string is transmitted to the communication system and then the determination of the digit string is carried out by the communication system from the character string that serves as a basis for the phone number of the communication partner.

4. The method according to claim 1, wherein the determination of the digit string is carried out by an independent ancillary device.

5. The method according to claim 1, wherein the determination of the digit string as the basis of the phone number is carried out by means of a server, via which the communication connection is set up, in particular via a server within the communication system.

6. The method according to claim 1, wherein the character string uniquely identifying the B subscriber is the first name and/or last name and/or an e-mail address, and/or an alias.

7. The method according to claim 1, wherein an identifier of the A subscriber is transmitted to the communication system for the establishment of a communication connection.

8. The method according to claim 1, wherein the character string is transmitted to the communication system by SMS, MMS, IM, e-mail or the like for the establishment of a communication connection.

9. The method according to claim 1, wherein a notification is transmitted to the B subscriber in the event of a failed or rejected connection setup, in particular containing an identifier of the A subscriber and/or call date and call time and/or the character string transmitted for identification of the B subscriber, in particular by SMS, MMS, IM or the like.

10. The method according to claim 1, wherein time restrictions or stipulations for a connection setup can be established, in particular times can be established in which no connection setup or only a connection setup with certain identifiers occurs, and/or that the time/date for a first attempt at a connection setup can be specified.

11. The method according to claim 1, wherein conference calls can be set up with any number of subscribers.
